(19) United States
(12) Patent Application Publication
(10) Pub. No.: US 2016/0017179 A1
(43) Pub. Date: Jan. 21, 2016

(54) HIGH-REACTIVITY POLYURETHANE COMPOSITIONS CONTAINING URETDIONE GROUPS AND COMPRISING CARBONATE SALTS

(71) Applicants: Emmanouil SPYROU, Schermbeck (DE); Andrea DIESVELD, Gescher (DE); Andrea THESING, Ahaus (DE); Holger LOESCH, Herne (DE)

(72) Inventors: Emmanouil SPYROU, Schermbeck (DE); Andrea DIESVELD, Gescher (DE); Andrea THESING, Ahaus (DE); Holger LOESCH, Herne (DE)

(73) Assignee: Evonik Degussa GmbH, Essen (DE)

(21) Appl. No.: 14/796,619

(22) Filed: Jul. 10, 2015

(30) Foreign Application Priority Data
Jul. 21, 2014 (DE) 102014214130.3

(51) Int. Cl. C09D 175/12; C09J 175/12

(52) U.S. Cl. CPC C09D 175/12; C09J 175/12

(57) ABSTRACT

A high-reactivity polyurethane composition useful in coatings and adhesives, contains the following components A)-D): A) 5 to 98.7 wt %, based on the total mass of the components, of at least one compound containing an uretdione group, and a free NCO content of less than 5 wt %, and an uretdione content of 2 to 25 wt %, based on i) aliphatic and/or (cyclo)aliphatic and/or cycloaliphatic polyisocyanates and ii) compounds containing hydroxyl groups; B) 0.2 to 5 wt %, based on the total mass of the components, of at least one catalyst selected from the group consisting of a substituted carbonate salt having a quaternary ammonium counterion, a substituted carbonate salt having a quaternary phosphonium counterion and mixtures thereof; C) 0.1 to 10 wt %, based on the total mass of the components, of at least one cocatalyst having at least one epoxide group; D) 1 to 90 wt %, based on the total mass of the components, of at least one polymer containing a hydroxyl group and having an OH number of between 20 and 1000 mg KOH/gram; wherein a sum of all components A)-D) is 100 wt %.

### BACKGROUND OF THE INVENTION

1. Field of the Invention

The invention relates to a high-reactivity polyurethane composition containing an uretdione group and curing at low baking temperatures, to a preparation process and to the use thereof for producing a coating material, especially film-forming coatings and adhesives and also plastics.

2. Discussion of the Background

Externally or internally blocked polyisocyanates represent valuable crosslinkers for thermally crosslinkable polyurethane (PU) coating and adhesive compositions.

Thus, for example, DE A 27 35 497 describes PU coating materials having outstanding weathering stability and thermal stability. The crosslinkers whose preparation is described in DE A 27 12 931 consist of isophorone diisocyanate which contains isocyanurate groups and is blocked with ε-caprolactam. Also known are polyisocyanates containing urethane groups, biuret groups or urea groups, the isocyanate groups of these polyisocyanates being likewise blocked.

The disadvantage of these externally blocked systems lies in the elimination of the blocking agent during the thermal crosslinking reaction. Since the blocking agent may therefore be emitted to the environment, it is necessary on environmental and workplace safety grounds to take special precautions to clean the outgoing air and recover the blocking agent. Moreover, the crosslinkers have low reactivity. Curing temperatures of more than 170° C. are needed.

DE A 30 30 539 and DE A 30 30 572 describe processes for preparing polyaddition compounds which contain uretdione groups and whose terminal isocyanate groups are blocked irreversibly with monoalcohols or monoamines. Of particular disadvantage are the chain-terminating constituents of the crosslinkers, leading to low network densities in the PU coatings and hence to moderate solvent resistances.

Hydroxyl-terminated polyaddition compounds containing uretdione groups are a subject of EP 0 669 353. On account of their functionality of two, they exhibit improved resistance toward solvents. A feature common to compositions based on these polyisocyanates containing uretdione groups is that they do not emit any volatile compounds in the curing reaction. The baking temperatures, however, at not less than 180° C., are at a high level.

The use of amidines as catalysts in PU coating composition is described in EP 0 803 524. While these catalysts do lead to a reduction in the curing temperature, they nevertheless exhibit considerable yellowing, which is generally unwanted in the coatings sector. The cause of this yellowing is thought to be the reactive nitrogen atoms in the amidines. They are able to react with atmospheric oxygen to form N-oxides, which are responsible for the discolouration.

EP 0 803 524 also mentions other catalysts which have been used for this purpose to date, but without exhibiting any particular effect on the curing temperature. They include the organometallic catalysts known from polyurethane chemistry, such as dibutyltin dilaurate (DBTL), for example, or else tertiary amines, such as 1,4-diazabicylco[2.2.2]octane (DABCO), for example.

WO 00/34355 claims catalysts based on metal acetylacetonates, for example zinc acetylacetonate. Catalysts of these kinds are actually capable of lowering the curing temperature of polyurethane powder coating compositions containing uretdione groups. (M. Gedan-Smolka, F. Lehmann, D. Lehmann “New catalysts for the low temperature curing of uretdione powder coatings” International Waterborne, High solids and Powder Coatings Symposium, New Orleans, 21-23 Feb. 2001). The use of metals in articles of everyday use is becoming increasingly debated on toxicological grounds; cf. the development of tributyltin catalysts.

Patent specifications WO2011124663, WO2011124664 and WO2011124665 claim the use of substituted carbonates as catalysts in coating systems, but none mentions polyurethane hardeners containing uretdione groups or mentions the additional use of cocatalysts containing epoxy groups.

### SUMMARY OF THE INVENTION

It was an object of the present invention, therefore, to find high-reactivity polyurethane compositions comprising uretdione groups that can be cured even at very low temperatures and which are suitable in particular for the production of plastics and also of high-gloss or matt, light-stable and weathering-stable, high-reactivity coatings, especially for paint and adhesive compositions. Moreover, on account of toxicological and workplace safety, no transition metals are to be used. In addition, the polyurethane compositions are required to exhibit good painting qualities after curing.

In one embodiment, the present invention relates to a high-reactivity polyurethane composition comprising an uretdione group, said composition comprising the following components A)-D):
A) 5 to 98.7 wt %, based on the total mass of the components, of at least one compound containing
   an uretdione group, and
   a free NCO content of less than 5 wt %, and
   an uretdione content of 2 to 25 wt %, based on i) aliphatic and/or (cyclo)aliphatic and/or cycloaliphatic polyisocyanates and ii) compounds containing hydroxyl groups;
B) 0.2 to 5 wt %, based on the total mass of the components, of at least one catalyst selected from the group consisting of a substituted carbonate salt having a quaternary ammonium counterion, a substituted carbonate salt having a quaternary phosphonium counterion and mixtures thereof;
C) 0.1 to 10 wt %, based on the total mass of the components, of at least one cocatalyst having at least one epoxide group;
D) 1 to 90 wt %, based on the total mass of the components, of at least one polymer containing a hydroxyl group and having an OH number of between 20 and 1000 mg KOH/gram;
wherein a sum of all components A)-D) is 100 wt %.

In another embodiment, the present invention relates to a high-reactivity polyurethane composition comprising an uretdione group, said composition comprising the following components A)-D) and at least one of the following components E)-G):
A) 5 to 98.7 wt %, based on the total mass of the components, of at least one compound containing
   an uretdione group, and
   a free NCO content of less than 5 wt %,
   an uretdione content of 2 to 25 wt %, based on i) aliphatic and/or (cyclo)aliphatic and/or cycloaliphatic polyisocyanates and ii) compounds containing hydroxyl groups;
B) 0.2 to 5 wt %, based on the total mass of the components, of at least one catalyst selected from the group consisting of a substituted carbonate salt having a quaternary ammonium counterion, a substituted carbonate salt having a quaternary phosphonium counterion and mixtures thereof;
C) 0.1 to 10 wt %, based on the total mass of the components, of at least one cocatalyst having at least one epoxide group;
D) 1 to 90 wt %, based on the total mass of the components, of at least one polymer containing a hydroxyl group and having an OH number of between 20 and 1000 mg KOH/gram;
E) 0.1 to 10 wt % of at least one acid in monomeric or polymeric form, based on the total mass of the components;
F) a solvent; and
G) an auxiliary, an adjuvant or mixtures thereof;
wherein the sum of all components A)-G) is 100 wt %.

In yet another embodiment, the present invention relates to a process for preparing the above polyurethane composition, comprising:

reacting components A)-D) in a heatable assembly at a temperature below 130° C.

The present invention also relates to a coating composition, comprising: the above polyurethane composition. The coating composition can be an adhesive or sealant.

### DETAILED DESCRIPTION OF THE INVENTION

All ranges herein below include all values and subvalues between the lower limit and the upper limit of the range.

Surprisingly it has been found that the purely organic catalysts of the invention accelerate the redissociation of uretdione groups so strongly that when components containing uretdione groups are used, the curing temperature of polyurethane compositions can be lowered considerably.

Conventional paint compositions and adhesive compositions containing uretdione groups can be cured under standard conditions (DBTL catalysis) only at or above 180° C. (Pieter Gillis de Lange, Powder Coatings and Technology, Vincentz Verlag, 2004, chapter 3.3.2.2 p. 119

With the aid of the high-reactivity polyurethane compositions of the invention, which therefore cure at a low temperature, it is possible, with a curing temperature of 100 to 160° C., to save not only energy and cure time; instead, even many temperature-sensitive substrates can be coated or bonded, despite showing yellowing, decomposition and/or embrittlement phenomena that would be undesirable at 180° C. Besides metal, glass, wood, leather, plastics and MDF board, there are also certain aluminium substrates that are ideally suited to the process. In the case of the latter substrates, an excessive temperature load leads occasionally to an unwanted change in crystal structure.

Provided by the present invention are high-reactivity polyurethane compositions, containing uretdione groups, comprising
A) at least one compound containing uretdione groups and based on aliphatic, (cyclo)aliphatic and/or cycloaliphatic polyisocyanates and compounds containing hydroxyl groups, having a free NCO content of less than 5 wt % and a uretdione content of 2 to 25 wt %, in an amount of 5 to 98.7 wt %, based on the total mass of the components;
and
B) at least one catalyst selected from the group consisting of a substituted carbonate salt having quaternary ammonium counterions and/or quaternary phosphonium counterions, in an amount of 0.2 to 5 wt %, based on the total mass of the components;
C) at least one cocatalyst having at least one epoxide group, in a weight fraction, based on the total mass of the components, of 0.1 to 10 wt %;
D) at least one polymer containing hydroxyl groups and having an OH number of between 20 and 1000 mg KOH/gram, in an amount of 1 to 90 wt %, based on the total mass of the components
where the sum of all components A)-D) is 100 wt %.

The high-reactivity polyurethane compositions containing uretdione groups may further comprise at least one of the following components:
E) optionally at least one acid in monomeric or polymeric form, in a weight fraction, based on the total mass of the components, of 0.1 to 10 wt %;
F) optionally solvents;
G) optionally auxiliaries and adjuvants
where the sum of all components A)-G) is 100 wt %.

Also provided by the invention is a process for producing the polyurethane compositions in heatable assemblies at temperatures below 130° C.

Also provided by the invention is the use of the polyurethane compositions of the invention in coating compositions for metal, plastic, glass, wood, MDF (Middle Density Fibreboard) or leather substrates or other heat-resistant substrates.

Also provided by the invention is the use of the polyurethane compositions of the invention in adhesive compositions for bonds of metal, plastic, glass, wood, MDF or leather substrates or other heat-resistant substrates.

Likewise provided by the invention are metal-coating compositions, more particularly for car bodies, motorcycles and pedal cycles, parts of buildings and household appliances, wood-coating compositions, MDF coatings, glass-coating compositions, leather-coating compositions and plastic-coating compositions.

The invention also provides for the use of substituted carbonate salts having quaternary ammonium and/or phosphonium counterions as catalysts in polyurethane coating compositions, in combination with epoxides as acid scavengers, especially in coating and adhesive or sealant compositions.

“High-reactivity” in the context of this invention means that the polyurethane compositions of the invention containing uretdione groups cure at temperatures of 100 to 160° C., depending on the nature of the substrate.

This curing temperature is preferably 120 to 150° C., more preferably from 130 to 140° C. The time for the curing of the polyurethane composition of the invention is usually within 5 to 30 minutes.

Polyisocyanates comprising uretdione groups as starting compounds for component A) are well-known, being described in U.S. Pat. No. 4,476,054, U.S. Pat. No. 4,912,210, U.S. Pat. No. 4,929,724 and EP 0 417 603, for example. A comprehensive overview of industrially relevant methods for dimerization of isocyanates to uretdiones is found in J. Prakt. Chem. 336 (1994) 185-200. The conversion of isocyanates into uretdiones is generally carried out in the presence of soluble dimerization catalysts, such as, for example, dialkylaminopyridines, trialkylphosphines, phosphoramides or imidazoles. The reaction, optionally carried out in solvents, but preferably in the absence of solvents, is stopped—by addition of catalyst poisons—once a desired degree of conversion is attained. Excess isocyanate monomer is subsequently separated off by short-path evaporation. When the catalyst is sufficiently volatile, the catalyst may be removed from the reaction mixture in the course of monomer removal. The addition of catalyst poisons may be eschewed in this case. In principle, a wide range of isocyanates are useful for preparing polyisocyanates A) comprising uretdione groups.

The di- and polyisocyanates used according to the invention for preparing the uretdiones A) may consist of any desired aromatic, aliphatic, cycloaliphatic and/or (cyclo)aliphatic di- and/or polyisocyanates. (Cyclo)aliphatic diisocyanates are well understood in the art as referring to both cyclically and aliphatically attached NCO groups, as is the case with isophorone diisocyanate for example. By contrast, cycloaliphatic diisocyanates are diisocyanates where only NCO groups are directly attached to the cycloaliphatic ring, e.g. H₁₂MDI.

In accordance with the invention the uretdiones A) are prepared using preferably isophorone diisocyanate (IPDI), hexamethylene diisocyanate (HDI), 2,2′-dicyclohexylmethane diisocyanate, 2,4′-dicyclohexylmethane diisocyanate, 4,4′-dicyclohexylmethane diisocyanate (H₁₂MDI), 2-methylpentamethylene diisocyanate (MPDI), 2,2,4-trimethylhexamethylene diisocyanate/2,4,4-trimethylhexamethylene diisocyanate (TMDI), norbornane diisocyanate (NBDI), 1,2- or 1,3- or 1,4-cyclohexyldi(methyl isocyanate), 1,2- or 1,3- or 1,4-xylylene disocyanate, alone or in mixtures. Especially preferred is the use of IPDI, H₁₂MDI and/or HDI, alone or in mixtures.

The conversion of these polyisocyanates carrying uretdione groups into compounds (curing agents) A) having uretdione groups entails the reaction of the free NCO groups with monomers or polymers containing hydroxyl groups, such as polyesters, polythioethers, polyethers, polycaprolactams, polyepoxides, polyesteramides, polyurethanes or low molecular mass di-, tri- and/or tetraalcohols as chain extenders, and optionally monoamines and/or monoalcohols as chain terminators, for example, and has been a frequent topic of description (EP 0 669 353, EP 0 669 354, DE 30 30 572, EP 0 639 598 or EP 0 803 524). Preferred compounds (curing agents) A) having uretdione groups have a free NCO content of less than 5 wt % and a uretdione group content of 2 to 25 wt % (calculated as C₂N₂O₂, molecular weight 84), preferably of 6 to 25 wt %. Preferred as chain extenders are polyesters and monomeric dialcohols. Apart from the uretdione groups, the compounds (curing agents) A) may also have isocyanurate, biuret, allophanate, urethane and/or urea structures.

Compounds A) containing uretdione groups and based on IPDI, H₁₂MDI and/or HDI, alone or in mixtures, are used with preference.

The catalysts B) essential to the invention are substituted carbonate salts with quaternary ammonium counterions and/or phosphonium counterions, as already described in WO2011124663, WO2011124664 and WO2011124665, for example.

Preferred catalysts B) conform to the formula 1:

(R′₄)Y⁽⁺⁾⁽⁻⁾OC(O)OR 1

where Y is either an N atom or a P atom, and R′ independently at each occurrence may be alkyl, aryl or aralkyl groups, and may also, moreover, be bridged or substituted, and R may be either H or alkyl, aryl or aralkyl groups. These substances may be prepared for example by reaction of quaternary ammonium or phosphonium hydroxides with dialkyl carbonates or diaryl carbonates, or by the reaction of tertiary amines and/or phosphines with dialkyl carbonates or diaryl carbonates.

In the case of bicarbonates as further preferred catalysts B), the formula is 2:

(R′₄)Y⁽⁺⁾⁽⁻⁾OC(O)O⁽⁻⁾Y⁽⁺⁾(R′₄) 2

with identical but independent definitions of the two R′ radicals as above. These bicarbonates may be prepared, for example, by reaction of quaternary ammonium or phosphonium hydroxides with carbon dioxide.

Preferred examples of such catalysts B) of the formula 1 or 2 are tetramethylammonium methylcarbonate, tetraethylammonium methylcarbonate, tetrapropylammonium methylcarbonate, tetrabutylammonium methylcarbonate, benzyltrimethylammonium methylcarbonate, benzyltriethylammonium methylcarbonate, tetramethylphosphonium methylcarbonate, tetraethylphosphonium methylcarbonate, tetrapropylphosphonium methylcarbonate, tetrabutylphosphonium methylcarbonate, benzyltrimethylphosphonium methylcarbonate, benzyltriethylphosphonium methylcarbonate, tetramethylammonium ethylcarbonate, tetraethylammonium ethylcarbonate, tetrapropylammonium ethylcarbonate, tetrabutylammonium ethylcarbonate, benzyltrimethylammonium ethylcarbonate, benzyltriethylammonium ethylcarbonate, tetramethylphosphonium ethylcarbonate, tetraethylphosphonium ethylcarbonate, tetrapropylphosphonium ethylcarbonate, tetrabutylphosphonium ethylcarbonate, benzyltrimethylphosphonium ethylcarbonate, benzyltriethylphosphonium ethylcarbonate, tetrabutylammonium bicarbonate, tetrahexylammonium bicarbonate, benzyltriethylammonium bicarbonate. It is of course also possible to use mixtures of such catalysts.

The catalysts are included in an amount of 0.2 to 5 wt %, preferably 0.4 to 3 wt %, based on the total mass of the components, in the polyurethane composition. The catalysts may comprise water of crystallization, in which case this water is not taken into account when the amount of catalyst used is calculated—that is, the amount of water is subtracted. Particular preference is given to using tetraethylammonium methylcarbonate and/or tetrabutylammonium methylcarbonate.

One variant according to the invention includes the polymeric attachment of such catalysts B) to the compounds (curing agents) A) or to the polymers C) containing hydroxyl groups. Thus, for example, free alcohol, thio or amino groups of the ammonium salts may be reacted with acid, isocyanate or glycidyl groups of the compounds (curing agents) A) or polymers C) containing hydroxyl groups, in order to integrate the catalysts B) into the polymeric system. Furthermore, these catalysts may be surrounded by an inert shell and hence encapsulated.

Compounds C) having epoxide groups are widely known within paint chemistry.

Those contemplated include preferably triglycidyl ether isocyanurate (TGIC), EPIKOTE® 828 (diglycidyl ether based on bisphenol A, Shell), Versatic acid glycidyl ester, terephthalic acid diglycidyl ether, trimellitic acid triglycidyl ether, ethylhexyl glycidyl ether, butylglycidyl ether, Polypox R 16 (pentaerythritol tetraglycidyl ether, UPPC AG) and other Polypox grades having free epoxy groups. Mixtures of such substances are of course also contemplated. Particular preference is given to terephthalic acid diglycidyl ether and trimellitic acid triglycidyl ether. These reactive compounds can be used in weight fractions of 0.1 to 10 wt %, preferably of 0.5 to 3 wt %, based on the total mass of the components.

In the case of the polymers D) containing hydroxyl groups, preference is given to using polyesters, polyethers, polyacrylates, polyurethanes, polyamidamines, polyethers and/or polycarbonates having an OH number of 20 to 1000 (in mg KOH/gram). Binders of these kinds have been described in EP 0 669 354 and EP 0 254 152, for example. Such polymers may be amorphous, crystalline or semicrystalline. It will be appreciated that mixtures of such polymers may also be used. They are included in an amount of 1 to 90 wt %, based on the total mass of the components, preferably 20-80 wt %.

Particularly preferred are polyesters having an OH number of 30 to 150, an average molecular weight of 500 to 6000 g/mol and an acid number of 3 to 10 mg KOH/g.

Acids specified under E) are all substances, solid or liquid, organic or inorganic, monomeric or polymeric, which possess the properties of a Brønsted acid or a Lewis acid. Examples include the following: sulphuric acid, acetic acid, benzoic acid, malonic acid, terephthalic acid, and also copolyesters or copolyamides having an acid number of at least 20 mg KOH/g. If used, they are included in an amount of from 0.1 to 10 wt %, based on the total mass of the components, preferably from 0.2 to 1 wt %.

Substances contemplated as solvents under F) are all liquid substances which do not react with other ingredients, examples being acetone, ethyl acetate, butyl acetate, xylene, Solvesso 100, Solvesso 150, methoxypropyl acetate and dibasic esters.

In accordance with the invention it is possible to add the customary adjuvants G) of coating or adhesive technology, such as flow control agents, examples being polysilicones or acrylates, light stabilizers, examples being sterically hindered amines, or other auxiliaries, as described in EP 0 669 353, for example, in a total amount of 0.05 to 5 wt %. Fillers and pigments such as titanium dioxide, for example, may be added in an amount of up to 50 wt % to the total composition.

The homogenization of all the constituents for producing the polyurethane composition of the invention may take place in suitable assemblies, such as heatable stirred tanks, kneading devices or else extruders, for example, and upper temperature limits of 120 to 130° C. ought not to be exceeded. The thoroughly mixed composition is applied to the substrate in an appropriate way, as for example by rolling, spraying, squirting, dipping or knifecoating, for example. Following this application, the coated workpieces are heated for curing to a temperature of 60 to 220° C. for 4 to 60 minutes, preferably at 80 to 160° C. for 6 to 30 minutes.

Having generally described this invention, a further understanding can be obtained by reference to certain specific examples which are provided herein for purposes of illustration only, and are not intended to be limiting unless otherwise specified.

### Examples

The subject matter of the invention is explained in more detail below, using examples.

Input Materials

| Input materials | Product description, manufacturer |
|---|---|
| VESTAGON BF 1320 | Component A), Evonik Degussa GmbH, Coatings |
| | & Colorants, IPDI-based, uretdione content: |
| | 13.2 wt %, T_{G}: 74-75° C. |
| TEAOH | Tetraethylammonium hydroxide, Aldrich |
| ARALDIT PT912 | Component C), epoxy component, Huntsman |
| | (mixture of terephthalic acid diglycidyl ether |
| | and trimellitic acid triglycidyl ether) |
| URALAC P1580 | Component D), polyester, OHN 81 mg KOH/g, |
| | Tg 54° C., Arkema |
| DMC | Dimethyl carbonate, Aldrich |
| Butyl acetate | Aldrich |

m.p.: melting point; T_{G}: Glass transition point; OHN: OH number.

2. Preparation of the Tetraethylammonium Methylcarbonate (TEAMC) Catalyst According to WO2011124663.

58.8 g of 25 wt % strength TEAOH solution in methanol were mixed with 38.8 g of dimethylcarbonate and left to stand for 24 hours. The excess methanol was then stripped off on a rotary evaporator at 230 mbar and RT, to give a 70 wt % strength catalyst solution in dimethyl carbonate. Complete reaction was verified by means of titration (HCl against methylene blue) and also by 13C NMR.

3. Coating Systems

(Data in Wt %)

| | VESTAGON | URALAC | | | Butyl |
|---|---|---|---|---|---|
| Examples | BF 1320 | P 1580 | TEAMC | PT 912 | acetate |
| 1* | 15.7 | 34.3 | | | 50.0 |
| 2* | 15.5 | 34.0 | 0.5 | | |
| 3 | 15.3 | 33.5 | 0.5 | 0.7 | 50.0 |

*non-inventive comparative examples

Vestagon BF 1320, URALAC P 1580 and any catalysts were dissolved at 50 wt % in butyl acetate and the solution was applied using a 50 um doctor to a steel panel. This was followed by baking at 150° C. for 10 minutes.

| | Ball impact | Erichsen | |
|---|---|---|---|
| | dir/rev | cupping | |
| Examples | [inch* lbs] | [mm] | Remarks |
| 1* | <10/<10 | 0.5 | not cured |
| 2* | 10/<10 | 0.5 | not cured |
| 3 | 80/80 | >10 | cured |

*non-inventive comparative examples

Inventive example 3 is fully cured and has good coatings-related mechanical properties.

Comparative examples 1* and 2* are not cured at all.

Ball impact to ASTM D 2794 93, Erichsen cupping to DIN 53 156

German patent application 102014214130.3 filed Jul. 21, 2014, is incorporated herein by reference.

Numerous modifications and variations on the present invention are possible in light of the above teachings. It is therefore to be understood that within the scope of the appended claims, the invention may be practiced otherwise than as specifically described herein.

1. A high-reactivity polyurethane composition comprising an uretdione group, said composition comprising the following components A)-D):
A) 5 to 98.7 wt %, based on the total mass of the components, of at least one compound containing
an uretdione group, and
a free NCO content of less than 5 wt %, and
an uretdione content of 2 to 25 wt %, based on i) aliphatic and/or (cyclo)aliphatic and/or cycloaliphatic polyisocyanates and ii) compounds containing hydroxyl groups;
B) 0.2 to 5 wt %, based on the total mass of the components, of at least one catalyst selected from the group consisting of a substituted carbonate salt having a quaternary ammonium counterion, a substituted carbonate salt having a quaternary phosphonium counterion and mixtures thereof;
C) 0.1 to 10 wt %, based on the total mass of the components, of at least one cocatalyst having at least one epoxide group;
D) 1 to 90 wt %, based on the total mass of the components, of at least one polymer containing a hydroxyl group and having an OH number of between 20 and 1000 mg KOH/gram;
wherein a sum of all components A)-D) is 100 wt %.

2. A high-reactivity polyurethane composition comprising an uretdione group, said composition comprising the following components A)-D) and at least one of the following components E)-G):
A) 5 to 98.7 wt %, based on the total mass of the components, of at least one compound containing
an uretdione group, and
a free NCO content of less than 5 wt %,
an uretdione content of 2 to 25 wt %, based on i) aliphatic and/or (cyclo)aliphatic and/or cycloaliphatic polyisocyanates and ii) compounds containing hydroxyl groups;
B) 0.2 to 5 wt %, based on the total mass of the components, of at least one catalyst selected from the group consisting of a substituted carbonate salt having a quaternary ammonium counterion, a substituted carbonate salt having a quaternary phosphonium counterion and mixtures thereof;
C) 0.1 to 10 wt %, based on the total mass of the components, of at least one cocatalyst having at least one epoxide group;
D) 1 to 90 wt %, based on the total mass of the components, of at least one polymer containing a hydroxyl group and having an OH number of between 20 and 1000 mg KOH/gram;
E) 0.1 to 10 wt % of at least one acid in monomeric or polymeric form, based on the total mass of the components;
F) a solvent; and
G) an auxiliary, an adjuvant or mixtures thereof
wherein the sum of all components A)-G) is 100 wt %.

3. The high-reactivity polyurethane composition according to claim 1, which comprises at least one compound A) based on isophorone diisocyanate (IPDI), hexamethylene diisocyanate (HDI), 2,2′-dicyclohexylmethane diisocyanate, 2,4′-dicyclohexylmethane diisocyanate, 4,4′-dicyclohexylmethane diisocyanate (H12MDI), 2-methylpentamethylene diisocyanate (MPDI), 2,2,4-trimethylhexamethylene diisocyanate/2,4,4-trimethylhexamethylene diisocyanate (TMDI), norbornane diisocyanate (NBDI), 1,2- or 1,3- or 1,4-cyclohexyldi(methyl isocyanate), 1,2- or 1,3- or 1,4-xylylene disocyanate, or mixtures thereof.

4. The high-reactivity polyurethane composition according to claim 1, which comprises compound A) based on IPDI, H12MDI, HDI, or mixtures thereof.

5. The high-reactivity polyurethane composition according to claim 1, comprising the catalyst B) of the formula 1:
(R′₄)Y⁽⁺⁾⁽⁻⁾OC(O)OR 1
wherein
Y is either an N atom or a P atom,
R′ is independently at each occurrence is an alkyl group, an aryl group or aralkyl group, and is optionally bridged or substituted, and
R is H, an alkyl group, an aryl group or an aralkyl group.

6. The high-reactivity polyurethane composition according to claim 1, comprising the catalyst B) of the formula 2:
(R′₄)Y⁽⁺⁾⁽⁻⁾OC(O)O⁽⁻⁾Y⁽⁺⁾(R′₄) 2
wherein Y is either an N atom or a P atom,
R′ is independently at each occurrence is an alkyl group, an aryl group or aralkyl group, and is optionally bridged or substituted, and
R is H, an alkyl group, an aryl group or an aralkyl group.

7. The high-reactivity polyurethane composition according to claim 1, wherein catalyst B) is selected from the group consisting of tetramethylammonium methylcarbonate, tetraethylammonium methylcarbonate, tetrapropylammonium methylcarbonate, tetrabutylammonium methylcarbonate, benzyltrimethylammonium methylcarbonate, benzyltriethylammonium methylcarbonate, tetramethylphosphonium methylcarbonate, tetraethylphosphonium methylcarbonate, tetrapropylphosphonium methylcarbonate, tetrabutylphosphonium methylcarbonate, benzyltrimethylphosphonium methylcarbonate, benzyltriethylphosphonium methylcarbonate, tetramethylammonium ethylcarbonate, tetraethylammonium ethylcarbonate, tetrapropylammonium ethylcarbonate, tetrabutylammonium ethylcarbonate, benzyltrimethylammonium ethylcarbonate, benzyltriethylammonium ethylcarbonate, tetramethylphosphonium ethylcarbonate, tetraethylphosphonium ethylcarbonate, tetrapropylphosphonium ethylcarbonate, tetrabutylphosphonium ethylcarbonate, benzyltrimethylphosphonium ethylcarbonate, benzyltriethylphosphonium ethylcarbonate, and also tetrabutylammonium bicarbonate, tetrahexylammonium bicarbonate, benzyltriethylammonium bicarbonate and mixtures thereof.

8. The high-reactivity polyurethane composition according to claim 1, wherein cocatalyst C) is selected from the group consisting of triglycidyl ether isocyanurate, diglycidyl ethers based on bisphenol A, Versatic acid glycidyl esters, terephthalic acid diglycidyl ether, trimellitic acid triglycidyl ether, ethylhexyl glycidyl ether, butyl glycidyl ether, pentaerythritol tetraglycidyl ether, polypox grades having a free epoxy group, and mixtures thereof.

9. The high-reactivity polyurethane composition according to claim 1, wherein polymer D) is selected from the group consisting of polyesters, polyethers, polyacrylates, polyurethanes, polyamideamines, polyethers, polycarbonates, each having an OH number of 20 to 1000 mg KOH/gram, and mixtures thereof.

10. The high-reactivity polyurethane composition according to claim 1, wherein polymer D) is selected from the group consisting of polyesters having an OH number of 30 to 150 mg KOH/g, an average molecular weight of 500 to 6000 g/mol and an acid number of 3 to 10 mg KOH/g.

11. The high-reactivity polyurethane composition according to claim 2, wherein acid E) is selected from the group consisting of sulphuric acid, acetic acid, benzoic acid, malonic acid, terephthalic acid, copolyesters and/or copolyamides having an acid number of at least 20 mg KOH/g, and mixtures thereof.

12. A process for preparing the polyurethane composition according to claim 1, comprising:
reacting components A)-D) in a heatable assembly at a temperature below 130° C.

13. A coating composition, comprising:
the polyurethane composition according to claim 1.

14. A substrate coated at least partially with the coating composition according to claim 13, wherein said substrate is selected from the group consisting of metal, plastic, glass, wood, MDF, leather substrates, other heat-resistant substrates and combinations thereof.

15. The coating composition of claim 13, which is an adhesive composition.

16. The coating composition of claim 13, which is a sealant composition.

17. The substrate according to claim 14, wherein said coating composition is an adhesive composition.

18. A coating composition, comprising:
the polyurethane composition according to claim 2.

19. The coating composition of claim 18, which is an adhesive composition.

20. The coating composition of claim 18, which is a sealant composition.
